(19) United States
(12) Patent Application Publication
(10) Pub. No.: US 2006/0186215 A1
(43) Pub. Date: Aug. 24, 2006

(54) Personalized control of water faucet functions

(76) Inventor: James D. Logan, Candia, NH (US)

Correspondence Address: CHARLES G. CALL, 68 HORSE POND ROAD, WEST YARMOUTH, MA, 02673-2516, US

(21) Appl. No.: 11/436,147

(22) Filed: May 17, 2006

Related U.S. Application Data
(60) Provisional application No. 60/681,834, filed on May 17, 2005.

(51) Int. Cl. G05D 23/13

(52) U.S. Cl. 236/12.2

(57) ABSTRACT

A faucet controller for accepting desired temperature, flow rate, spray configuration selections, and volume delivery limits from a user and for thereafter controlling the delivery of water through the faucet in accordance with the selections accepted from the user. A set of selector “preset” buttons is used to store the current flow state (temperature, flow rate, and spray configuration), as well as volume delivery limits when desired, and that stored state may then restored by pressing the present selector button used to store that prior state. A force feedback joystick may be used to control the faucet.

### FIELD OF THE INVENTION

This invention relates generally, although not exclusively, to a microprocessor-controlled water faucet capable of remembering and reproducing personalized temperature, flow-rate, and other faucet characteristics selected by a particular user.

### BACKGROUND OF THE INVENTION

Every day, 270 million Americans go to the sink and turn on the water. They adjust the flow through one or two valves to get the water to just the right temperature—the same temperature they used yesterday. Depending on the characteristics of the hot water supply system, the wait may be lengthy and requires substantially continuous attention from the person using the faucet. Moreover, once the valves are properly set, the water temperature may not remain constant during use, requiring readjustment.

Different people prefer to use water at different temperatures. One person may like to wash with cool water, another with warm water, and another with water that is quite hot.

The same person may desire a different temperature for different purposes. Most people prefer to drink cold water. A given person may want to use water at one temperature for washing dishes, a different temperature for rinsing fresh vegetables, and still another for making tea.

It is accordingly an object of the present invention to reliably, conveniently and automatically provide water from a faucet at a selected one of a plurality of desired temperatures chosen by users.

### SUMMARY OF THE INVENTION

The preferred embodiment of the invention takes the form of methods and/or apparatus for controlling the flow of water through a faucet. The flow control apparatus is coupled to conventional hot and cold water pipes via one or more electrically controllable valves which combines hot and cold water to deliver a mixture through said faucet at a controllable temperature and flow rate.

A display device, such as one or more LCD displays, is used to provide visual output information to the user. A storage device “remembers” a plurality of different sets of operating parameters, each of said sets containing at least specific temperature and a specific flow rate. A connected microprocessor is programmed to perform a plurality of operations including:
responding to control commands from a user indicating a desired temperature by displaying the desired temperature and transmitting control signals to the controllable valve(s) in order to deliver water through said faucet at the selected desired temperature,
responding to further control commands from said user indicating a desired flow rate by displaying the selected flow rate and transmitting control signals to the controllable valve(s) to deliver water through said faucet at said desired flow rate,
responding to a capture command from said user by storing the temperature and the flow rate at which water is currently being delivered through the faucet, later accepting a restore command from said user specifying a selected one of said sets of operating parameters and, in response to the restore command, transmitting control signals to the controllable valve(s) to again deliver water through said faucet at the temperature and flow rate contained in the selected one of said operating parameters.

The faucet control may further include a mechanism for selecting a particular spray configuration and for storing data indicating the desired spray configuration along with the temperature and flow rate designations so that the desired spray configuration can also be automatically restored to a remembered value when desired

The faucet control may also include a volume limit control which the user can employ to set a limit on the total volume of water that should be dispensed by the faucet each time it is turned on, with the faucet automatically turning off after the limit is reached, or issuing an alarm if the limit is exceeded.

The faucet may advantageously employ conventional faucet controls in combination with electronic controls. In addition, controls such as a joystick temperature and flow rate controller may employ force feedback to provide useful haptic indications to the user, giving the control a “feel” which is indicative of the function to be performed by the faucet or the faucet controller.

The invention may be advantageously implemented by the combination of one or more temperature sensors positioned to detect the temperature of the water flowing in the system, one or more flow meters for detecting the rate of flow, one or more valves controlled by electrical solenoids or the like to separately control flow rates for both hot and cold water, a microprocessor and clock, and an controllable spray head. A plurality of “state setting” pushbuttons or touch controls are connected to a microcontroller. When a button is pressed momentarily and released, the microprocessor adjusts the water temperature, flow rate, and spray to match a prior sensed state when that button was previously programmed. When the button is pressed for more than a predetermined duration, the microcontroller saves current state of the faucet temperature, flow rate and spray setting) for future use.

These and other features and advantages of the invention may be more clearly understood by considering the following detailed description. In the course of this description, reference will be made to the attached drawings:

### BRIEF DESCRIPTION OF THE DRAWINGS

FIG. 1 depicts a first illustrative control panel that may be used to implement the invention without additional controls;

FIG. 2 shows a second illustrative control panel that may be used in combination with separate controls for varying the water temperature, flow rate and spray characteristics for a faucet; and

FIG. 3 is a schematic diagram illustrating the principle components used in a preferred embodiment of the invention.

### DETAILED DESCRIPTION

The present invention, here called “Smart Water,” is preferably implemented as a micro-processor-based faucet system in which microprocessor-controlled valves are used to mix the water to a desired temperature, produce a desired flow rate, and select a desired nozzle spray setting, in response to a request by a user who merely pushes a button (or some other control) to activate personalized settings previously selected and stored by the user.

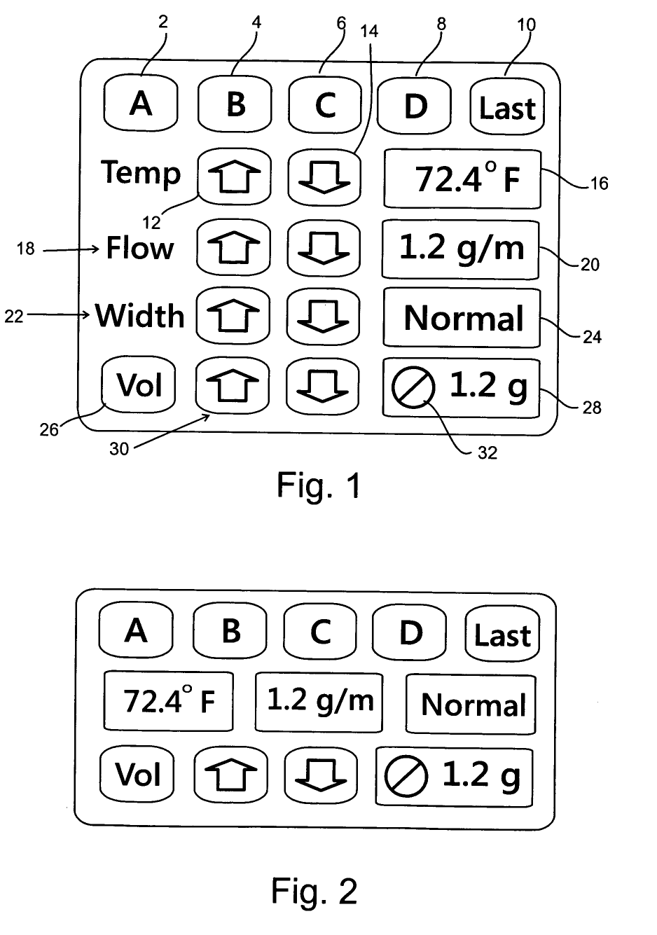

The preferred embodiment employs one or more separate push buttons or touch controls arrayed by the sink or faucet. An illustrative control panel for implementing the invention is seen in FIG. 1. These four “personal selection” buttons seen at 2, 4, 6 and 8 act in a way similar to the station selecting “preset” buttons in an automobile radio. Each time the temperature of the water flowing from the faucet is at a desired temperature, the user can and hold one of the buttons 2-8, thereby programming that button so that, when it is pressed again, a connected microprocessor controls the valves to achieve the same water temperature that was detected when the button was programmed. Note that one special preset button seen at 10 labeled “Last” is used to configure the water settings to whatever the remembered settings were the last time the faucet was used. In this case, the preset button 10 would never be explicitly be set as such but would rather be similar to a radio's on/off button where putting it into the “On” state sets the radio to the station and volume that was in use the last time the radio was on. Pressing this special preset button 10 a second time would turn the water off. Preferably, pressing an off the buttons 2-10 when the water is running turns the water off, and permits a new personalized setting to be entered by pressing one of the buttons 2-8.

When the water is flowing, an “up button” 12 may be pressed to increase the water temperature and a “down button” 14 may be pressed to decrease the water temperature. An LCD display seen at 16 displays the current water temperature.

The invention may control not only water temperature but also water pressure (and hence flow rate). As indicated generally at 18, up and down buttons may be pressed to increase or decrease the current rate at which water flows from the faucet, and this rate is displayed by the LCD 20 in gallons/minute.

In the same fashion, using the up and down controls seen generally at 22, the user can adjust the nozzle spray “width” from an narrow focused spray to wide “sprinkler” setting. The LCD display at 24 shows the current spray width setting. Thus, a user may adjust the temperature and flow rate to a level desired for hand washing, press a given one of the buttons 2-8 for an extended period (say 2 seconds) to store those settings, and return the water flow to that temperature and flow rate whenever the given button is again pressed. If the faucet is equipped with a variable spray nozzle, the spray characteristics selected at 22 may also be “remembered” when a button 2-10 is pressed to save a current set of operating parameters for the faucet system.

The controls seen at the bottom of the control panel shown in FIG. 1 may be used to select the volume of water that will be allowed to flow before it is automatically shut off, or before a warning alarm is issued. By pressing the “Vol” button 26 sequentially, the LCD display at 28 sequentially displays the current mode settings which consist of an OFF mode in which the LCD 28 displays “OFF,” a “LIMIT” mode in which the LCD 28 displays an icon seen at 32 and a numerical indication of a volume limit setting, and “WARN” mode in which the LCD 28 displays the combination of an alarm icon (not shown) and a volume limit setting at which an audible alarm is issued. If the water is running, this mode display is temporary and the LCD display 28 then shows the current volume of water that has passed through the faucet since it was last turned on. If the “OFF” mode is selected, the display 28 continues to display “OFF” until a different mode is selected by again pressing the Vol button 26. If the LIMIT or ALARM modes are selected, the user can press the up and down buttons indicated generally at 30 to change the limit setting. When the up or down buttons 30 are pressed, the LCD again displays the current volume limit setting as it is adjusted using the buttons 30. The volume mode settings, like the temperature, flow rate, and spray width settings, are “remembered” when a user presses one of the preset buttons 2-8 for an extended period and then, when that preset button is again pressed, the faucet turns on and delivers water at the temperature, flow rate and spray setting previously stored and associated with that button and, if a volume limit setting in not “OFF,” the water automatically shuts off or an alarm indicating that the preset volume limit has been exceeded is issued.

As discussed in more detail below, conventional faucet controls, or separate special controls, may be used to select the water temperature, flow rate and nozzle settings. In this case, control panel of the type seen in FIG. 2 may be employed. The buttons and display LCDs are the same as those discussed above in connection with FIG. 1, but the up and down button controls for temperature, flow rate and nozzle settings are eliminated, since their function is instead performed by external controls as discussed below.

The invention may be applied to advantage in faucets used at kitchen and bathroom sinks, in showers, or in commercial settings with similar plumbing fixtures.

The preferred embodiment of the invention would allow the user to either use the traditional faucet controls or the presets, or both. The system's ability to allow both methods to be used means that a user could use a preset to reconfigure the settings after the water was turned on manually, or alternatively, use the manual faucets to modify the parameters set via use of a pushbutton.

Thus, a user could first turn on the water manually without using a pre-set, using either a single-lever faucet control or one relying on both hot and cold water handles. After manually turning on the water, the user could then hit one of the presets to have the water parameters be automatically reset thus over-riding whatever manual settings had been achieved to that point in time.

Alternatively, the user could first hit a preset button and water with the desired properties would immediately come out. Following this action, the user could use the manual faucets to modify these automatic settings.

Turning off the water could be done by re-hitting the original preset button, hitting a universal “off” button, or using the faucet hardware. An elegant feature associated with the water shutting off via a preset is that it could shut off in a gradual fashion, in much the way that the lights slowly dim in an expensive car when the door is closed.

In order for both manual and automatic controls to operable at any time, the flow valves for both hot and cold water must be controlled by the microprocessor. That is, if the manual control can over-ride the automatic control, and visa versa, then they both must control the same valve.

The manual faucet controls ideally will therefore have the same “feel” as manual controls even though they are controlling an electronic circuit and not directly opening and closing a valve. Such electronic control of the manual faucet, however, would allow for the user to “calibrate” the feel of the handle. That is, the resistance to rotation and the degree to which the handle had to turn to release a certain amount of water could both be controllable via electronics.

In one implementation of such a software controlled “faucet feel”, the flow rate or temperature changing capability of the faucet or faucets could be non-linear. In a totally manual mode, this might mean that the first quarter-turn of the faucet increased flow by 100% but the next quarter turn only increased it 25%. Alternatively, the user could use a preset and then modify this setting with a “fine-tuning” motion off the faucet where a large faucet motion resulted in just a small change in flow or temperature. As the human body is extremely sensitive to temperatures around the scalding temperature of water, it would be useful to have non-linearity appear in the temperature control means when the system gets close to such temperature.

Note also, that in a scenario where the user presses a preset button to start the flow and the faucet is being used to merely “annotate” the automatic settings, the faucet (once the preset had been pressed) would not necessarily need to have a “stop” or “start” point. Like certain types of radio dials, it could keep turning making continuous adjustments to the water settings.

If force-feedback (that is, variable resistant applied to the faucet as a function of a certain parameter reading) were available, it would be possible to modulate the ease-of-movement of the faucet in order to apply increasing resistance as the temperature exceeded a certain level. As a safety precaution, overly-hot water could be prevented from flowing either by via software control whereby turning the faucet fails to release further dangerous levels of hot water or via force-feedback where the user would not physically be able to turn the faucet to a level that would create water that was too hot. Note, that in a two-faucet setup (that is, one having a separate hot and cold water handle) the system's software can prevent overly hot water by either keeping the cold water from being turned too far down, or the hot water turned too far up.

The system could also operate with two separate temperature sensors placed before the mixing valve as opposed to one temperature sensor after the mixing of hot and cold water. Using such a configuration, the system could deduce the resultant mixed temperature by knowing the volumes and temperatures of the two flows being mixed.

Ideally, any temperature gauges would have a fast “settling” time. The software modulating the mix of hot and cold water would take into account the settling time in order to reach the desired temperature quickly.

Temperature equilibrium is also affected by the rate at which the pipes heat up. The system would “learn” this dynamic by watching the temperature rise after setting a certain flow rate after a period of non-use. This information regarding pipe temperature equilibrium could be used to appropriately increase the initial flow of hot water and then diminish it later as the water temperature rose to equilibrium.

Once the desired temperature is reached, an audible or visual signal could be given to notify the user. The signal could be analog in nature, indicating how close to the desired temperature the water was.

Another need for dynamic temperature adjustment might be in the case where the user wanted to temperature of the discharged water to change over time. This might be the case in a shower where the user might want to increase the shower temperature over time. This could be programmed explicitly with an enhanced interface with LCD, or could be learned by the system through “example” whereby the user demonstrated how the water temperature should change over time.

The problem of slightly changing the shower water temperature over time might also be addressed with real-time adjustments by the user. This might best be done via the use of an easy to use digital temperature adjustment control instead of trying to tweak an analog faucet to increase the temperature a small amount. Thus, to offer this feature, the system would include a two buttons or a toggle switch that increased or decreased the temperature by a set increment.

It is also important to note that the system could be usefully implemented without the inclusion of any temperature sensors at all. In this design, the user would adjust the mix of hot and cold water to his or her liking and hit the preset. The system would not know the numerical temperature of this desired setting, but would know how to reproduce it by recording the positions of the respective hot and cold valve settings.

For determining overall water flow volume, two separate flow meters could also be placed before the mixing valve as opposed to a single flow meter after hot and cold water were mixed.

By the same token, the system could also be operable without flow meters. That is, so long as the system knows what positions the valves were in when the desired volume of water was reached, that volume could again be reproduced without necessarily knowing its numerical value.

The microcontroller can also be programmed to perform other desirable functions: a desired “on time” can be associated with each pushbutton. Thus, for washing hands, the faucet can not only deliver water at a preselected temperature, flow rate and spray setting, but may also automatically turn off the water after a preset time has elapsed. This timing feature can be particularly useful in a shower to automatically turn of the water after a predetermined time to encourage water conservation. Or a user could hit a button to fill a tub or pasta pot with water at a pre-set temperature, walk away to do other things, and come back later knowing that the water had turned off at the right time. The user can, of course, press the button again to resume the shower or add more water to the tub. In the case of the shower, subsequent presses can provide even shorter ON periods, thereby discouraging long showers that waste water and raise the cost of heating the excessive water used.

This On-Time feature (or “volume” setting) could be a stand alone one actuated with a separate set of buttons or a control such as dial that could be spun to the appropriate amount and then pressed or pulled, much like how a washing machine if filled up after specifying how full the washer is. The volume settings could be set around the dial in a linear or non-linear fashion.

Without such explicit means available for specifying volumes, the system might depend on the user inputting this data via “example” and associating this information with a preset. With this method, the user could input the volume value for a preset at the same time that the temperature is set by, for instance, by pressing and holding the preset a second time during the “calibrating” fill-up. Upon such action the system would record the volume of water that would be dispensed during this “user experience”. Audio prompts could be used to guide the user along during this “programming period”.

Volume settings, having thus been associated with specific presets could then always be “active” or could be invoked upon command. That is, some presets could have volumes associated with them at all times. For example, preset number 4 could have associated with it the volume of water needed whereas preset 3 would let the water run until turned off. In another implementation, however, the user would have to actuate the preset in a certain way to invoke the volume setting, perhaps by double tapping the button.

In a case where a volume setting is not associated with a preset, the volume could be specified in real time. This could be done by holding down the preset for a set time period (longer than the time needed to setup the preset in the first instance) while audio prompts called out the duration options.

Once the proper volume had been dispensed, the system could emit an audible tone, similar to how a microwave notifies the user when an item is done.

To set the spray format a similar set of issues arise and similar need exists for special input means. For instance the user could double tap the preset after the press-and-hold action to set the spray method.

An elegant feature associated with the use of the volume control for filling up a tub would be the ability of the system to add additional water during the course of the bath to keep the temperature comfortable. This could be done via “pattern matching”. That is, the system could add water in the same pattern that it was added in an “example” fill-up by the user. An alternative less-automated means to achieve the same result would be to include in the system a “refresh” button by the tub. Hitting this button would release a set volume of water at a set temp, bringing the water back to temperature without the user having to monitor the addition of new water.

The use of the volume feature in conjunction with a tub differs from other uses, such as filling up a pasta pot in two ways. First, the volume desired would be much greater (so the fill-up time would be greater and the corresponding time-saving from automating the task greater). Secondly, if automated the user never has to be there to start the tub fill-up whereas the user must be present to start a process such as filling up a pasta pot. As such, it would be beneficial to have the tub-filling feature operable via a remote control or other remote means such as Bluetooth or WiFi. It could also be scheduled to occur at a set time via scheduling input supplied over the Internet or via a control panel.

To enhance the user interface, an output display (such as a numerical LCD display positioned near the pushbuttons) can be used to display current water temperature, flow rate, spray setting, desired volume, etc. In a further enhancement, the display can be made interactive and used to program the pushbutton controls. In this manner, the user could directly select from the displayed options temperature and other parameters such as flow rate, spray setting, and volume. If necessary, a mode select button may be pressed to cycle the display from one parameter to the next, and a pair of up-down buttons may be used to adjust the temperature, flow rate, spray setting, or volume amount-to a desired value, which has the effect of resetting the remembered state value associated with the currently operative button.

In a more intensive interactive use of the visual display, the preset buttons themselves could be replaced by buttons around the display or by buttons on the display if a touch screen were used.

With such a flexible interface, personalized options could be presented for different users and/or different options could be presented at different times or day or different days of the week or year.

The interactive display could further beneficial in that it could present visual icons representing the choices available. Icons of hand-washing, pasta pots, steaming water and the like could serve to make it easier to select from among the sets of preset parameter settings (e.g. pushbutton options).

By way of example, the user can press the button or icon associated with hand washing. The microprocessor then turns on the water flow, selects the remembered spray setting, and adjusts the relative flow from the hot and cold water sources in an effort to obtain the recalled desired temperature. Typically, some time will be required for the water to reach the desired temperature, and during that time the LCD display shows the measured temperature, thereby indicating to the user when the water temperature is acceptable to begin use. If the user then wants to adjust the flow rate, the mode select button can be pressed until the current flow rate is displayed on the LCD, and then the up-down buttons may be pressed to set the flow rate at the desired level. By pressing the mode select repeatedly, different parameters may be displayed and, if desired, adjusted.

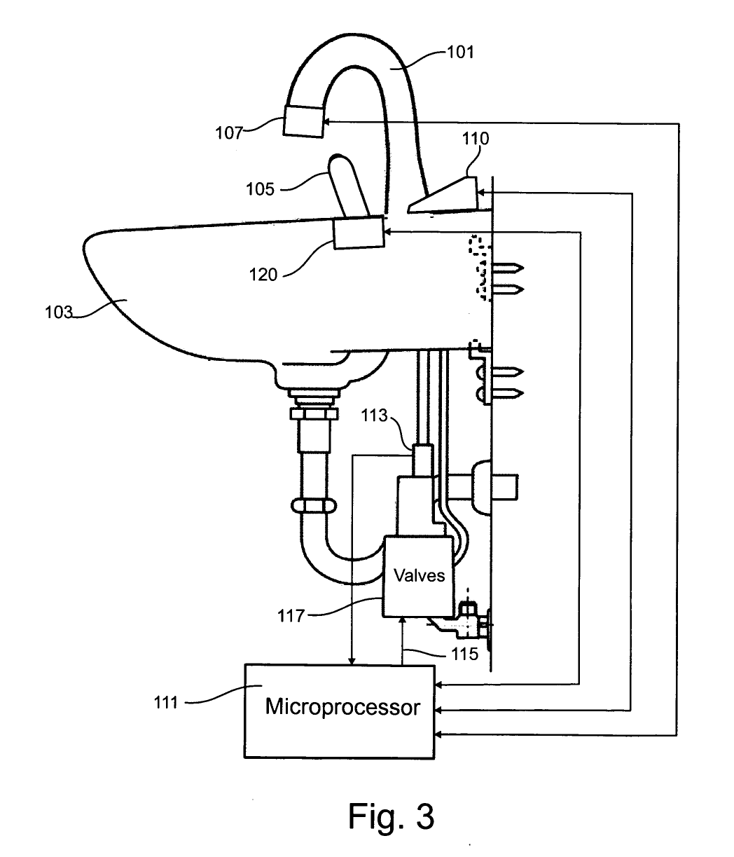

An illustrative implementation of a preferred embodiment of the invention is seen in FIG. 3. As shown, the invention is used to control the flow of water through sink faucet seen at 101 mounted on a conventional sink 103. The flow of water is controlled using a “joystick” handle seen at 105 which is moved forward and back to control water flow, and moved from side to side to control water temperature. A thumb-operated rotary wheel control on the distal end of the joystick 105 is moved to control the spray width from a controllable nozzle 107.

A control panel of the kind shown in FIGS. 1 or 2 is located in a housing seen at 110 which may contain a microprocessor and suitable device interconnection circuitry; however, the microprocessor is shown separately at 111 for purposes of illustration. The microprocessor 111 receives signals from sensors located at 113 which can include a temperature sensor for sensing the temperature of water flowing through the nozzle 101 and a pressure or flow rate sensor for providing a signal value from which the flow rate through the nozzle 101 can be determined. The microprocessor provides control signals along the pathway 115 for controlling flow control valves in a housing 117 which control the incoming flow through both the incoming cold and hot water lines for controlling both the total flow rate and the “mix” of hot and cold water needed to achieve a desired temperature manually selected using the joystick 105 and/or stored preset temperature and flow rate values selected by the user using the control panel 110.

As suggested earlier, the manual control handle may advantageously take the form of a force feedback device capable of producing tactile signals to the user which provide an appropriate “feel” to the control. For example, the control may simulate a springlike behavior in which it may be urged from a central position to change a current setting at a rate of change proportional to the degree of handle deflection, and force feedback may be applied to the handle to urge it back to the neutral central position with the applied feedback force increasing with the degree of deflection. As another example, if an attempt is made to select a temperature which is greater than a predetermined “comfort” limit, an increasing level of vibration may be applied to the joystick handle to warn the user that the temperature selected may be too high. The force feedback joystick controller servos and electronics are mounted within the housing seen at 120 and may take be implemented as an Exos Force Feedback Joystick as described in U.S. Pat. No. 5,742,278 issued to Elaine Chen et al. on Apr. 28, 1998, the disclosure of which is incorporated herein by reference.

The microprocessor 111 performs a variety of functions, including:
a) receiving and processing control signals from the control panel 110 and/or from the joystick controller 120 to operate the valves 117 so that water is delivered through the nozzle 101 at a flow rate and at a temperature selected by the user;
b) receiving and processing control signals from the control panel 110 and/or from the thumbwheel of the joystick 105 to control the setting of the spray nozzle 107 on the faucet 101;
c) accepting volume limit settings from the control panel 110 and either automatically turning off the water flow when that volume limit has been reached, or activating an audible or visual alarm (or both) when that volume limit has been exceeded;
d) storing the current temperature, flow rate, spray nozzle setting, and volume limit settings and associating those stored parameters with a given preset button when that button is depressed for an extended time;
e) recalling stored parameter settings when a preset button is pressed while the water is turned off, and then delivering water to the faucet at the temperature, flow rate and nozzle settings that were associated with the pressed preset button;
f) delivering force feedback control signals to the joystick controller 120 to provide haptic information to the user while the joystick is being manipulated; and
g) limiting water temperatures, flow rates, and flow volumes in ways that protect users against harm and conserve energy.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. Apparatus for controlling the operation of a faucet comprising, in combination;
a water delivery system including a temperature controller for delivering water through said faucet at a controllable temperature and a flow rate controller for varying the rate at which water flows through said faucet, said water delivery system including a microprocessor programmed to:
a) accept a temperature selection command from a user and to transmit commands to said temperature controller to adjust the temperature of said water flowing through said faucet to a selected temperature,
b) accept a flow rate selection command from said user and to transmit commands to said flow rate controller to adjust the rate at which said water flows through said faucet to a selected flow rate,
c) accept a capture command from a user for storing data values indicative of said selected temperature and said selected flow rate at the time said capture command is accepted, and
d) accept a restore command from a user for retrieving previously stored data values and, responsive to said restore command, to employ said data values as retrieved to transmit commands to said water delivery system to deliver water through said faucet at said selected temperature and said selected flow rate.

2. Apparatus for controlling the operation of a faucet as set forth in claim 1 wherein said water delivery system further includes a spray controller for producing different selectable water spray patterns from said faucet, and wherein said microcontroller is further programmed to:
f) accept a spray selection command from a user to select a given one of said selectable water spray patterns, and
g) storing a further data value indicative of said given one of said selectable water spray patterns in response to said capture command, and
h) responsive to said restore command, employing said further data value to transmit a command to said spray controller to deliver water through said faucet in said given one of said water spray patterns.

3. Apparatus for controlling the operation of a faucet as set forth in claim 2 further including a display device controlled by said microcontroller for displaying said selected temperature specified by said temperature selection command.

4. Apparatus for controlling the operation of a faucet as set forth in claim 3 wherein said display device further displays said selected flow rate specified by said flow rate selection command.

5. Apparatus for controlling the operation of a faucet as set forth in claim 4 wherein said microcontroller is further programmed to accept a flow volume limit quantity from a user and to perform a defined action when the amount of water flowing through said faucet exceeds said flow volume limit quantity.

6. Apparatus for controlling the operation of a faucet as set forth in claim 2 wherein said microcontroller is further programmed to accept a flow volume limit quantity from a user and to perform a defined action when the amount of water flowing through said faucet exceeds said flow volume limit quantity.

7. Apparatus for controlling the operation of a faucet as set forth in claim 6 wherein said defined action is the activation of an alarm.

8. Apparatus for controlling the operation of a faucet as set forth in claim 6 wherein said defined action is the transmission of a turnoff command to said flow rate controller to terminate the flow of water through said faucet.

9. Apparatus for controlling the operation of a faucet as set forth in claim 6 wherein said microcontroller is further programmed to accept a flow volume limit quantity from a user and to perform an defined action when the amount of water flowing through said faucet after it flow commences exceeds said flow volume limit quantity.

10. Apparatus for controlling the operation of a faucet as set forth in claim 1 further including a display device controlled by said microcontroller for displaying said selected temperature specified by said temperature selection command.

11. Apparatus for controlling the operation of a faucet as set forth in claim 10 wherein said display device further displays said selected flow rate specified by said flow rate selection command.

12. Apparatus for controlling the operation of a faucet as set forth in claim 11 wherein said microcontroller is further programmed to accept a flow volume limit quantity from a user and to perform an defined action when the amount of water flowing through said faucet after it flow commences exceeds said flow volume limit quantity.

13. Apparatus for controlling the operation of a faucet as set forth in claim 1 wherein said microcontroller is further programmed to accept a flow volume limit quantity from a user and to perform an defined action when the amount of water flowing through said faucet after it flow commences exceeds said flow volume limit quantity.

14. Apparatus for controlling the operation of a faucet as set forth in claim 13 wherein said defined action is the activation of an alarm.

15. Apparatus for controlling the operation of a faucet as set forth in claim 13 wherein said defined action is the transmission of a turnoff command to said flow rate controller to terminate the flow of water through said faucet.

16. Apparatus for controlling the operation of a faucet as set forth in claim 1 wherein said water delivery system further includes a controllable spray nozzle for delivering controllable spray configurations into the air from said faucet and wherein said microprocessor is further programmed to accept a spray configuration selection command from a user to adjust the configuration of the spray from said nozzle.

17. Apparatus for controlling the flow of water through a faucet comprising, in combination,
a source of hot water,
a source of cold water,
one or more electrically controllable valves for combining water from said source of hot water and from said source of cold water to deliver water through said faucet at a controllable temperature and flow rate,
an input device for supplying control commands from a user,
a display device for providing visual output information to said user, and
a microprocessor programmed to perform operations including:
responding to control commands from a user indicating a desired temperature by displaying said desired temperature on said display device and transmitting control signals to said one or more electrically controllable valves to deliver water through said faucet at said desired temperature, and
responding to said commands from said user indicating a desired flow rate by displaying said desired flow rate on said display device and transmitting control signals to said one or more electrically controllable valves to deliver water through said faucet at said desired flow rate.

18. Apparatus for controlling the flow of water through a faucet as set forth in claim 17 wherein said microprocessor is further programmed:
1) to accept a capture command from said input device;
2) to respond to said capture command by storing the specific temperature and the specific current flow rate at which water is being delivered through said faucet at the time said capture command is accepted;
3) to thereafter accept a restore command from said input device, and
4) to respond to said restore command by transmitting control signals to said one or more controllable valves to again deliver water through said faucet at said specific temperature and said specific flow rate.

19. Apparatus for controlling the flow of water through a faucet as set forth in claim 18 wherein said microprocessor is further programmed to respond to different identifiable capture commands by storing different identifiable data sets each consisting of a specific temperature and a specific flow rate, and to thereafter respond to a restore command associated with one of said identifiable capture commands for transmitting control signals to said one or more controllable valves to again deliver water through said faucet at the specific temperature and specific flow rate contained a selected one of said identifiable data sets.

20. Apparatus for controlling the flow of water through a faucet comprising, in combination,
a source of hot water,
a source of cold water,
one or more electrically controllable valves for combining water from said source of hot water and from said source of cold water to deliver water through said faucet at a controllable temperature and flow rate,
a display device for providing visual output information to said user,
a storage device for storing a plurality of different sets of operating parameters, each of said sets containing a specific temperature and a specific flow rate, and
a microprocessor programmed to perform operations including:
responding to control commands from a user indicating a desired temperature by displaying said desired temperature on said display device and transmitting control signals to said one or more electrically controllable valves to deliver water through said faucet at said desired temperature,
responding to further control commands from said user indicating a desired flow rate by displaying said desired flow rate on said display device and transmitting control signals to said one or more electrically controllable valves to deliver water through said faucet at said desired flow rate,
responding to a capture command from said user by storing the temperature and the flow rate at which water is being delivered through said faucet at the time said capture command is accepted in said storage device in one of said sets of operating parameters,
accepting a restore command from said user specifying a selected one of said sets of operating parameters, and
responsive to said restore command, transmitting control signals to said one or more controllable valves to again deliver water through said faucet at the temperature and flow rate contained in said selected one of said operating parameters.
